(19) United States
(12) Patent Application Publication
(10) Pub. No.: US 2012/0197566 A1
(43) Pub. Date: Aug. 2, 2012

(54) INSTRUMENTATION FOR MEASUREMENT OF CAPACITANCE AND RESISTANCE AT HIGH RESISTANCE VALUES WITH IMPROVED DYNAMIC RANGE AND METHOD FOR USING SAME

(75) Inventors: Dejan S. Habic, Windham, NH (US); Jeffrey C. Andle, Falmouth, ME (US)

(73) Assignee: DELAWARE CAPITAL FORMATION, INC., Wilmington, DE (US)

(21) Appl. No.: 13/017,386

(22) Filed: Jan. 31, 2011

(51) Int. Cl. G06F 19/00

(52) U.S. Cl. 702/65

(57) ABSTRACT

A system and methods including a direct ramp measurement method and a free running oscillator method is used to measure electrical properties of a material in contact with a sensor. Digital control of signal generation and switching cover a wider measurement range, but still maintain the relaxation oscillator running in an optimal frequency range. A variable amplitude voltage generator and independently controlled switching levels depend on measurement range and voltage generator level.

### FIELD OF THE INVENTION

The invention relates to a method and apparatus to measure electrical properties of sensing elements or materials; more specifically, high sensitivity and dynamic range autonomous measurement of the resistance and capacitance of sensing elements or the conductivity and dielectric constant of materials.

### BACKGROUND OF THE INVENTION

There is a need for an improved means of measuring the conductivity and dielectric constant of materials. In one such group of applications, liquids, such as lubricants, fuels, and hydraulic fluids benefit from continuous condition based monitoring that includes conductivity and dielectric measurements. In other applications, such as medium and high voltage power transmission or radio frequency transmission, the integrity of the transmission lines is of critical importance and the ability to quantify leakage currents and line capacitance is of critical interest. Present approaches fail in areas of one or more of: operation autonomy, sensitivity, range, sampling frequency, and electrostatic fouling. Solutions would (a) be autonomous so as to require low processor burden in multi-sensor systems, (b) be sufficiently sensitive to allow conductivity measurement of pure hydrocarbon liquids or highly insulating gases or polymers (σ<1000 pS/m; εᵣ˜2), (c) have sufficient dynamic range to allow the use of deionized (DI) water as a calibration standard (σ→1 μS/m and εᵣ→100), (d) obtain reliable measurements at least once per second, and (e) employ a symmetric, alternating potential to prevent electrostatic fouling of the electrodes and/or interference of the measurement from small leakage currents.

Some approaches use off the shelf ICs to measure capacitance. Delta sigma (ΔΣ) capacitance-to-digital converters can provide some level of accuracy, but do not provide conductivity measurements. U.S. Patent Application Publication number 2010/0188111, titled: “Apparatus and Method for the Measurement of Electrical Conductivity and Dielectric Constant of High Impedance Fluids”, filed Jan. 29, 2009 to Fougere describes a system in which a computing circuit generates a waveform using a digital to analog converter to excite a conductivity cell and the received and amplified signal is digitized. While the system offers a direct measurement of conductivity; it fails to provide autonomous operation and requires considerable processor overhead. It does not have sufficient dynamic range to measure both very low conductivity samples and still use water as a low cost calibration fluid. Nor can it obtain both conductivity and dielectric measurements of suitable accuracy once per second in many implementations.

Another approach is reported in “A CMOS Integrable Oscillator Based Front End for High Dynamic Range Resistive Sensors”, by De Marcellis, A.; Depari, A.; Ferri, G.; Flammini, A.; Marioli, D.; Stornelli, V.; Taroni, A., IEEE Transactions on Instrumentation and Measurement, Volume 57, Issue 8, August 2008 Page(s):1596-1604; hereafter “De Marcellis et al.”. This paper describes a circuit (See FIG. 1A) in which a relaxation oscillator toggles the polarity of a driving square wave of amplitude A. The driving potential is applied to a driven electrode of the fluid cell and a short circuit current of the receiving electrode is integrated in an op amp integrator. The output of the integrator comprises a switching transient and a voltage ramp (See FIG. 1B). The switching transient is proportional to the driving voltage and the ratio of the fluid cell capacitance to the integrator capacitance. The ramp rate is equal to the ratio of the fluid cell conductance to the integrator capacitance. The toggling of the driving potential polarity is controlled by a trigger level obtained as an inverted multiple of the source voltage. Interval T_{C1} is the reduced linear ramp time interval between a switching transient and a zero crossing of the negative going ramp during a positive drive signal phase. Interval T_{C2} is the time interval of the remainder of the negative going ramp from the zero crossing to the negative trigger. Because of the finite discontinuity, T_{C1}<T_{C2}. T_{C3} is the reduced linear ramp time interval between a switching transient and a zero crossing of the positive going ramp during a negative drive signal phase. Interval T_{C4} is the time interval of the remainder of the positive going ramp from the zero crossing to the positive trigger. Because of the finite discontinuity, T_{C3}<T_{C4}. In the absence of leakage currents or imbalances in the drive and trigger levels, T_{C1}=T_{C3} and T_{C2}=T_{C4}.

The De Marcellis et al. sensor measures conductivity and dielectric constant of materials using a relaxation oscillator in which the frequency changes with conductivity and/or capacitance between two contact nodes. The resistance-to-time converter is implemented using a simple time interval measurement of two signals corresponding to changes of resistance or capacitance. Calculation of conductivity and dielectric constant is performed by the processor using known cell constant and calibration data. The De Marcellis et al. circuit is drawn to the measurement of metal oxide and related chemiresistive films of high resistance and moderate dielectric constant using solid state, photolithographic methods of electrode construction.

For the De Marcellis et al. device, the frequency at which the relaxation oscillator runs is related to the inverse of the Cᵢ/G_{f} time constant of the integrator capacitor and the fluid cell conductance. The constant by which the two are related is fixed by the gain determined by R2/R1. High gain lowers the frequency.

For very low conductivities, the time between measurements is very large because the period of the wave is very large as a result of the slow ramp rate. On the other hand, for high conductivities, significant errors are incurred because the speed of the waveform is fast compared to the electronics.

A paper entitled “Novel Method for Static Dielectric Constant Measurement of Liquids”, by Anil Tidar, S. P. Kamble, S. S. Patil, B. R. Sharma, P. W. Khirade and S. C. Mehrotra and published in the Sensors & Transducers Journal vol. 123, issue 12, December 2010 employs an external trigger source to excite a monostable multivibrator. The pulse width is determined by an external resistor and the capacitance of a fluid cell. The method is limited to the measurement of low conductivity fluids and cannot measure conductivity.

Problems with current systems include at least: a measurement time that is relatively long and greatly varies with conductivity range, the comparator speed plays a critical role for higher conductivities, capacitance measurement accuracy is related to and constrained by conductivity range, and fixed gain.

IEC61620 details a standard for measuring conductivity and dielectric properties of highly insulating fluids that is consistent with De Marcellis et al. However, the standard employs a driving signal and a receiver and, as such, is not autonomous.

### SUMMARY OF THE INVENTION

Based on the shortcomings of the prior art and the need to measure fuels, lubricants, and electrical insulators (including liquid, gaseous or solid materials) in myriad industrial process control and asset management scenarios, new circuits and methods of instrumenting circuits are required. Embodiments provide higher accuracy, better stability and repeatability over a wide measurement range, as well as the ability to control and parameterize the measurement frequency.

In yet other applications, chemically or physically varying resistance or capacitance of a semiconductor or polymer sensing element is measured with high resolution and reproducibility.

An embodiment provides a system for instrumenting a sensor for measuring electrical properties of a material comprising a sensor having an input and an output, interfaced with a first drive signal source, the source driving a first polarity switching means driving the input of the sensor with the drive signal of the first drive signal source, wherein the drive signal is applied with alternating polarity; an integrator integrating the output current of the sensor, the output current responsive to the input voltage of the first drive signal; the integrator response further coupled to a first comparator, the comparator comparing the output of the integrator to a constant reference level and generating a first digital output signal; a second comparator, the comparator comparing the output of the integrator to an alternating polarity reference and providing a second digital output signal, the alternating polarity reference obtained from a second polarity switching means providing the alternating polarity reference voltage, the second polarity switching means switching the polarity of a signal obtained from a second drive signal source; wherein the second digital signal controls the first and second polarity switching means, the digital output signals being coupled to a computing means, the computing means analyzing times between transitions of the digital signals to determine the electrical properties of the material, the electrical properties comprising at least one of conductivity, resistivity, conductance, resistance, dielectric constant, dielectric loss tangent, or capacitance, wherein the computing means further controls the amplitude of at least one of the first and second drive signals. In another embodiment, the amplitude of the first drive voltage signal is adaptively controlled to prevent electrolysis of the material being measured. For a following embodiment, the first drive voltage signal is derived from a digital to analog converter (DAC). In a next embodiment, the second drive voltage signal is generated by a digital to analog converter (DAC). In a yet further embodiment, the first switching means comprises a comparator and the first drive voltage signal is derived from power supplies of the comparator. A subsequent embodiment comprises a free running relaxation oscillator, wherein output of the integrator is further coupled to a data acquisition means accomplishing digitization of at least a portion of the output of the integrator, wherein the computing means estimates slopes and discontinuities of the output and estimates the material's electrical properties therefrom. For an embodiment, the digitization comprises digitizing a free running waveform and then identifying features of measurement. Other embodiments comprise a free running relaxation oscillator with at least one of the first and second drive signals adaptively controlled, whereby time intervals are optimized for measurement quality. For another embodiment, the free running relaxation oscillator is controlled to control measurement frequency at a desired frequency. In additional embodiments, the free running relaxation oscillator sequentially adaptively controls the at least one drive level to sequentially perform measurements of the material at a plurality of frequencies, so as to determine dependence of the measured electrical parameters on frequency. In an embodiment, sampling frequency is at least about approximately about 1,000 samples for each measurement cycle. In a yet further embodiment, sampling frequency is about approximately between 0.5 and 1 Ms/s. For following embodiments, asymmetry is monitored, leakage current is estimated, and time intervals are compensated for the leakage current.

Another embodiment provides a system for instrumenting a sensor for measuring electrical properties of a material comprising a sensor having an input and an output, interfaced with a drive signal source; the source driving a polarity switching means driving an input of the sensor with the drive signal input voltage applied with alternating polarity; an integrator integrating output current of the sensor, the output current responsive to the input voltage; the integrator response further coupled to a data acquisition means for the purpose of digitization of at least a portion of the output of the integrator into a computing means; the computing means estimating the slopes and discontinuities of the integrator output; estimating the material's electrical properties therefrom; and the alternation of the drive signal polarity further controlled by the computing means. In an embodiment, sampling frequency is at least about approximately 1,000 samples for each measurement cycle. In another embodiment, sampling frequency is about approximately between 0.5 and 1 Ms/s.

A subsequent embodiment provides a method for measuring electrical properties of a material in contact with a sensor comprising the steps of performing, at each event associated with a change of state of digital signals of an instrumentation means; collecting a time stamp; determining which phase of a waveform corresponds to the event; recording a time interval; optionally estimating a frequency; estimating sensor capacitance at a predetermined subset of the events; and adjusting digital to analog converter DAC outputs at a predetermined subset of the events; whereby at least one of the drive level and the trigger level is adaptively controlled to maintain the time intervals or the frequency within a desired range. In further embodiments, the time intervals are averaged. For other embodiments, a single frequency is used. In yet other embodiments, multiple frequencies are used sequentially. Yet other further embodiments comprise triggering on a level less than a switching level; digitizing a rising slope to a second trigger level under software control; estimating at least one of the rising slope and a falling slope; switching a drive signal; digitizing a signal until a third trigger level is reached under software control; estimating at least one of the rising slope and the falling slope; and estimating a discontinuity at switching time.

Yet another embodiment provides a method for measuring electrical properties of a material in contact with a sensor comprising the steps of initiating an analog to digital converter (ADC) by a trigger signal; sampling a first predetermined number of samples; switching polarity after the first predetermined number of samples are collected; sampling a second predetermined number of samples; estimating at least one of an ascending ramp rate or a descending ramp rate from the collected first predetermined number of samples and estimating the other of the ascending ramp rate or the descending ramp rate from the collected second predetermined number of samples; further estimating a discontinuity (β) from difference of these linear extrapolations to switching time; and estimating the electrical properties of the material using at least one of the slopes and the discontinuity.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1 depicts a prior art measurement circuit block diagram 1A and prior art timing diagram 1B.

FIG. 2 depicts a simplified component embodiment diagram configured in accordance with the present invention.

FIG. 3 depicts a component embodiment diagram configured in accordance with the present invention.

FIG. 4 depicts another simplified component embodiment diagram configured in accordance with the present invention.

FIG. 5 depicts another component embodiment diagram configured in accordance with the present invention.

FIG. 6 is a depiction of timing slope and drop results for an embodiment configured in accordance with the present invention.

FIG. 7 depicts non-ideal behavior experienced in certain circuits and cells.

FIG. 8 is a first flow chart of a method configured in accordance with the present invention.

FIG. 9 is a second flow chart of a method configured in accordance with the present invention.

### DETAILED DESCRIPTION

Embodiment features comprise the following. 1) A free running relaxation oscillator with drive level A and/or trigger level B adaptively controlled to optimize time intervals T1-T4 for measurement quality. 2) Level A and/or B being adjusted to control measurement frequency at a desired frequency. 3) Optionally using a plurality of frequencies to determine the dependence of parameters on frequency. 4) Free running relaxation oscillator as above using time interval measurement to estimate R (G) and C. 5) Free running relaxation oscillator as above using digitization of the waveform and estimating the slopes and discontinuities. 6) Digitizing the free running waveform and then identifying the features of the measurement. 7) Triggering on a level less than the switching level, digitizing a rising slope to a second trigger level under software control, estimating a rising (falling) slope, switching the drive signal, digitizing the signal until a third trigger level under software control, estimating a falling (rising) slope, and estimating a discontinuity at the switching time. 8) A forced circuit in which a drive signal is applied, a response is digitized, and the drive signal is switched, in which one of the above methods is applied.

Applications are drawn to employing one or more of the above embodiments to the measurement of one or more of: the capacitance and/or resistance of a sensing element; the conductivity and/or dielectric constant of a solid; the conductivity and/or dielectric constant of a liquid. In one such set of applications, the sensor element is a two-terminal, lumped element device exhibiting a resistance or capacitance responsive to a physical or chemical influence. In another set of applications, the system and method are employed to test the integrity of an electronic cable such as might be employed in communications or in power transmission and distribution. By examining the capacitance and resistance seen at the end of a cable as a function of measurement frequency, it is possible to selectively control the length of cable responsive to the instrument. In yet another set of applications, the sensing element is a measurement fixture of known geometry constructed to receive a solid or liquid sample whose intrinsic conductivity and dielectric constant are to be determined or monitored.

In embodiments of the present invention, a fixed amplitude of the drive signal is replaced with a variable amplitude derived, by way of non-limiting example, from a digital to analog converter (DAC). The variable drive level allows the drive amplitude, A, to be adjusted. This proportionally adjusts the short circuit current into the integrator in proportion to A and directly alters the rate of the integrator voltage ramp. Reducing A in high conductivity fluids will slow down the relaxation oscillator, reducing errors associated with finite electronics switching speeds. Increasing A in low conductivity fluids will speed up the relaxation oscillator, allowing measurements at the desired rate of at least one per second at correspondingly lower conductivity.

For embodiments, the trigger level amplitude is generated by a DAC with the polarity made opposite that of the drive signal. Increasing the trigger level, B, causes the relaxation oscillator to slow down, reducing the errors associated with finite electronics switching speeds. Decreasing B in low conductivity fluids will speed up the relaxation oscillator by triggering at a lower point on the ramp waveform, allowing measurements at the desired rate of at least one per second at correspondingly lower conductivity.

Therefore, the relaxation oscillator frequency is scalable from a nominal value by A/B. In embodiments, low cost DACs with 10 bits of accuracy offering a 1000:1 range are employed. A 100:1 range is possible with good reproducibility. The frequency can be varied over a four order of magnitude range for a given fluid. This increases the dynamic range of conductivity by as much as four orders of magnitude for the same upper and lower frequency bounds of the instrumentation.

For embodiments, there exists a practical limit on the ratio of A/B. The switching discontinuity, β, in the output waveform due to the cell capacitance, is given as:

β=ACs/Ci 1)

Where Cs is cell capacitance and Ci is integrator capacitance. In an embodiment, the discontinuity, β, is less than the trigger level magnitude, B:

β=ACs/Ci<B 2)

This results in a “capacitance ratio” constraint of the relative increase of the relaxation oscillator frequency as:

B/A<Cs/Ci 3)

This limitation can occur in embodiments in which the zero crossing is used to determine a time interval. If the constraint is not met, then the switching step can cause the output to swing through zero.

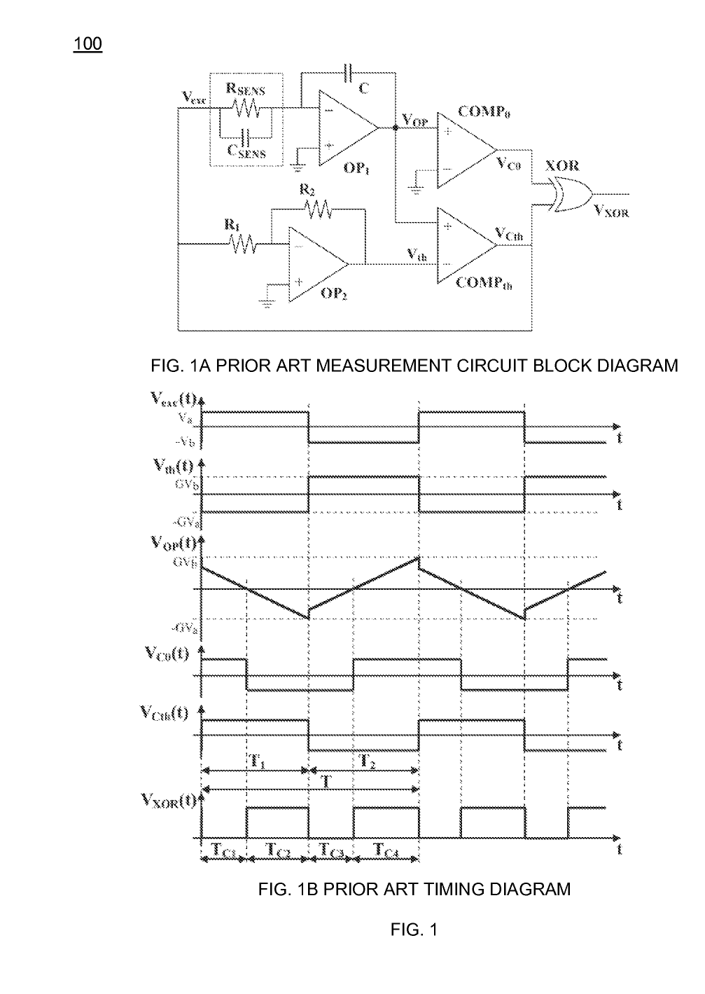

Therefore, in at least one embodiment of the present invention, the time intervals of the four phases of the relaxation oscillator are measured as in relation to De Marcellis et al. (FIG. 1B: T_{C1}, T_{C2}, T_{C3}, T_{C4}); however, in distinction, the DAC levels are adjusted to maintain a relatively constant frequency subject to the constraint of the capacitance ratio.

For an embodiment, the zero crossing is detected by one comparator and a trigger level threshold is detected by another comparator. The trigger level comparator initiates a change of polarity. The signals—either individually or jointly through an XOR gate—are applied to one or more input capture pins of a microprocessor. At each input capture event: 1) a process (such as an interrupt service routine) is executed that 2) collects the time stamp, 3) determines which phase of the waveform corresponds to the event, 4) determines and records the time interval, 5) estimates the frequency and 6) capacitance ratios, and 7) adjusts the DAC outputs accordingly.

In embodiments, the successive time intervals are compensated for known dependence on the drive and trigger levels and the compensated values are averaged.

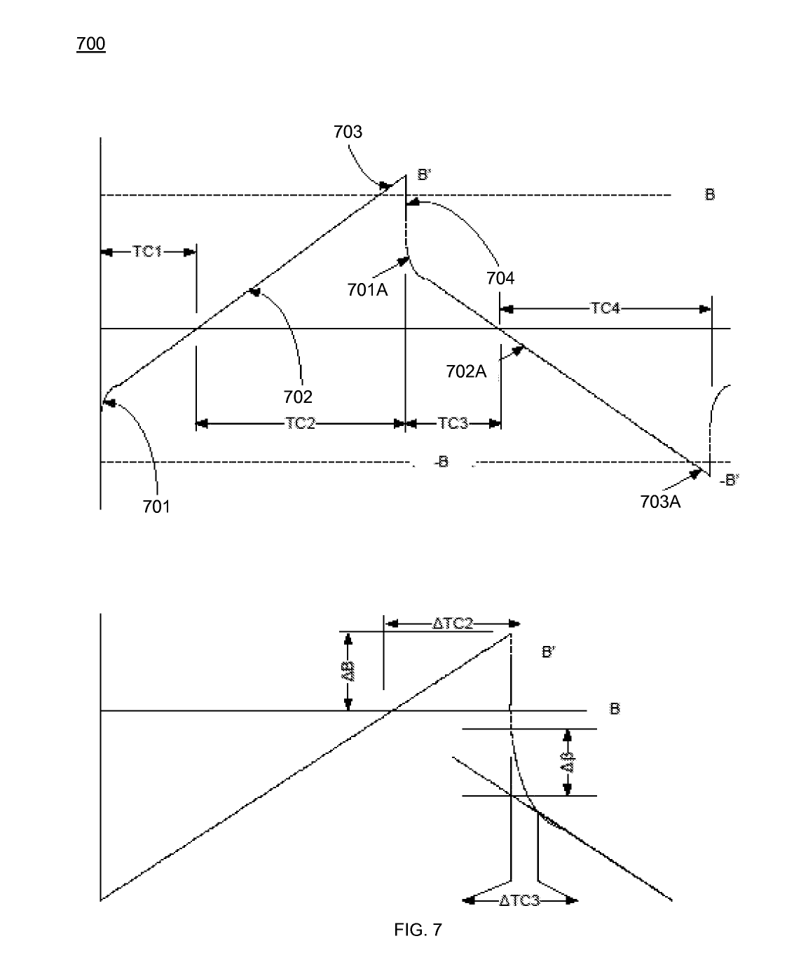

In an ideal system T_{C1}=T_{C3} and T_{C2}=T_{C4} (as in segments in FIG. 7). For actual systems, an asymmetry in the waveform can result from imbalances in the drive and trigger levels (which can be corrected at the time of manufacture), or from leakage currents into or out of the measurement electrodes. In an embodiment, the asymmetry is monitored, the leakage current is estimated, and the time intervals are compensated for the leakage current.

In another such embodiment, the amplitude trigger does not initiate a change of polarity. Instead, 1) the trigger signal 2) initiates an analog to digital converter (ADC) to begin sampling a number, N1, of samples; 3) after the samples are collected, the polarity is switched and 4) the waveform continues to be digitized for an additional N2 samples; 5) the ascending and descending ramp rates are estimated from the N1 and N2 samples or vice versa; and 6) the discontinuity, β, is estimated from the difference of these linear extrapolations to the switching time. In this method, the frequency is only significant in that it controls the period at which measurements are made and the ramp rate is controlled to obtain desired measurement parameters. The drive signal, A, can be increased to maximize the resolution of the dielectric constant measurement. It may also be adjusted to optimize the duration of the digitization process and the numerical accuracy of the slope calculations. Furthermore, the discontinuity may traverse a zero crossing. The numbers of samples, N1 and N2, may be fixed parameters, or may be determined by the arbitrary number of samples taken in a voltage interval or in a time interval. The constraint on the relationship of A and B in this case becomes:

β=ACs/Ci<2B 4)

Embodiments are able to determine, through a series of measurements, both an ascending and a descending discontinuity and ramp rate. Ideally, these values are identical; however leakage currents and parasitic capacitances may unbalance the measurement and may be detected in differential comparison of the up and down ramp results, as in the time interval embodiments.

Embodiments include circuits employing relaxation oscillator resistance-to-time circuits measuring conductivity and dielectric constant that measure resistance ranging from about 1 KΩ to about 100 GΩ and parallel capacitance up to about 150 pF. Other ranges of total resistance or capacitance are also accessible through the use of larger or smaller integrating capacitances and time scales and the design rules can be readily determined. From this, conductivity and dielectric constant of a material are calculated in some embodiments using a known cell constant. In at least one measured case, embodiments' circuitry covers a very wide range of conductivities (from 500 pS/m to several million pS/m) and relative dielectric constants (from 1 to up to 80 or more). By changing the geometry of electrodes, consequently increasing or decreasing the cell constant, different ranges of conductivity and dielectric constant are attainable for a given circuit.

R-T conversion is performed by an integrator stage comprised of an operational amplifier and a capacitor (for example, C=100 pF). It integrates the sensor current, which can be modeled using a resistance R_{SENS} in parallel with a capacitance C_{SENS}. Since sensor excitation voltage A (V_{exc}), for a time period, is constant, the integrator output V_{OP} is, in the same period, a falling or a rising ramp, depending on the sensor current direction.

The ramp is compared, by comparator COMPₜₕ, (255 in FIG. with a threshold B (Vₜₕ) that follows, with the opposite sign, excitation voltage A (V_{exc}). COMPₜₕ generates a logic signal V_{Cth}, whose period T_{C} is proportional to sensor resistance R_{SENS} according to:

$${T}_{C} = 4 \frac{B}{A} {CR}_{SENS} ( 1 - ( \frac{{C}_{SENS}}{\frac{B}{A} C} ) ) \qquad 5 )$$

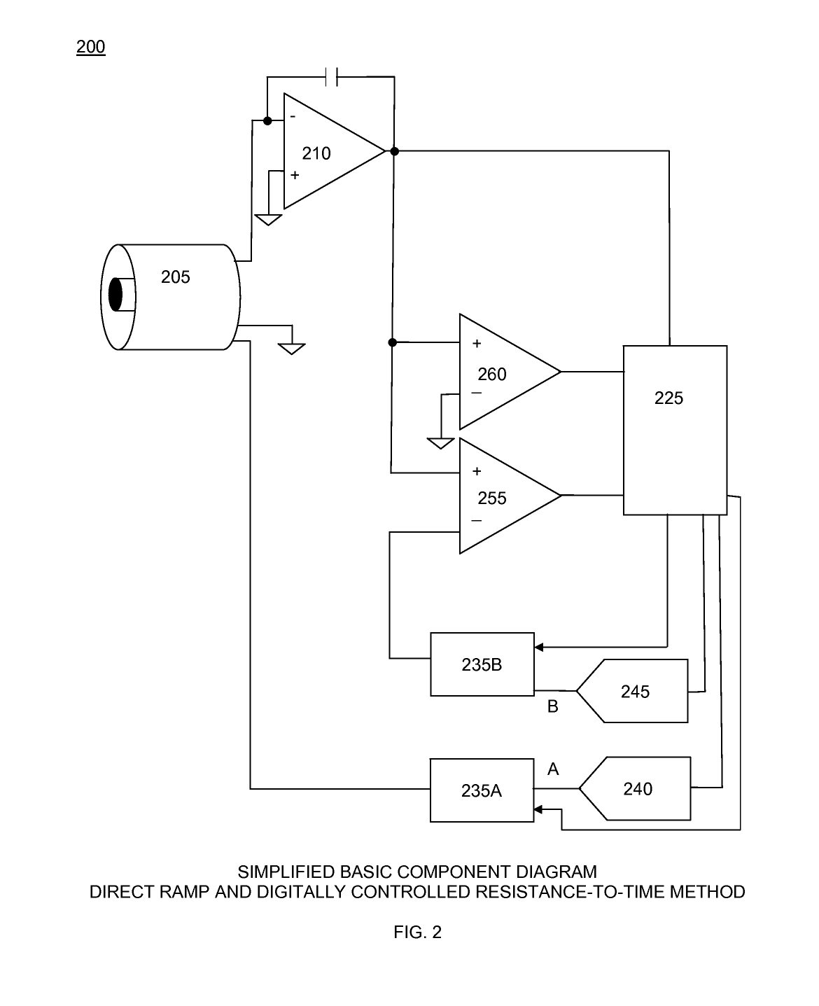

Sensor capacitance C_{SENS} involves a charge transfer, which affects the ramp signal when a voltage commutation occurs, through a vertical edge on V_{OP}, as can be seen in FIG. 7. Comparator COMP₀ (260 in FIG. 2) separates ramp signals in two parts: the first part, immediately after the commutation, presents the charge transfer effect due to C_{SENS}, whereas the second part depends on R_{SENS} only. This allows the estimation of both the C_{SENS} and R_{SENS} values, according to

$$\begin{matrix}{R}_{SENS} = \frac{{T}_{C 2} + {T}_{C 4}}{2 \frac{B}{A} C} & 6 ) \\ {C}_{SENS} = \frac{B}{A} C \frac{( {T}_{C 2} + {T}_{C 4} - {T}_{C 1} - {T}_{C 3} )}{2 {T}_{C 2} + 2 {T}_{C 4}} & 7 )\end{matrix}$$

where the increasing and decreasing ramp contributions have been averaged.

The work of De Marcellis et al. has a constant ratio of the trigger level, B, to the drive level, A, being a fixed value of R₂/R₁. In distinction from De Marcellis et al., by allowing the ratio of B/A to be varied, the present invention allows modification of the period, T_{C}, and the ranges of resistance (conductivity) and capacitance (dielectric constant) by dynamically varying this ratio.

### Digitally Controlled Resistance-to-Time Method

In embodiments, reduced resource requirements may be attained by continuing to employ time interval measurements, but with more digital controls, specifically in signal generation and switching. In order to cover a wider measurement range, but still keep the relaxation oscillator running in an optimal frequency range, a variable amplitude voltage generator (A or V_{exc}) is implemented in embodiments. In addition, switching levels (GV_{B} and GV_{A}) are controlled separately (“B”) depending on a desired measurement range and the voltage generator level (A or V_{exc}).

FIG. 2 depicts a simplified component embodiment diagram 200 configured in accordance with the present invention. Components comprise sensor 205; precision amp 210; microcontroller unit (MCU) 225; first polarity switch 235A; second polay s1itch 235B; first DAC1 240 to provide first adjustable signal level, A; second DAC2 245 to provide second adjustable signal, B, comparator 260 comparing the output of integrator 210 against a constant (e.g. ground) potential and comparator 255 comparing the output of integrator 210 against the polarity switched reference derived from B. DAC2 245 determines amplitude B and, with polarity alternator second switch 235A controls the reference level applied to comparator 255. DAC1 240 and polarity alternator first switch 235B drive sensor 205 with alternating drive level of amplitude A.

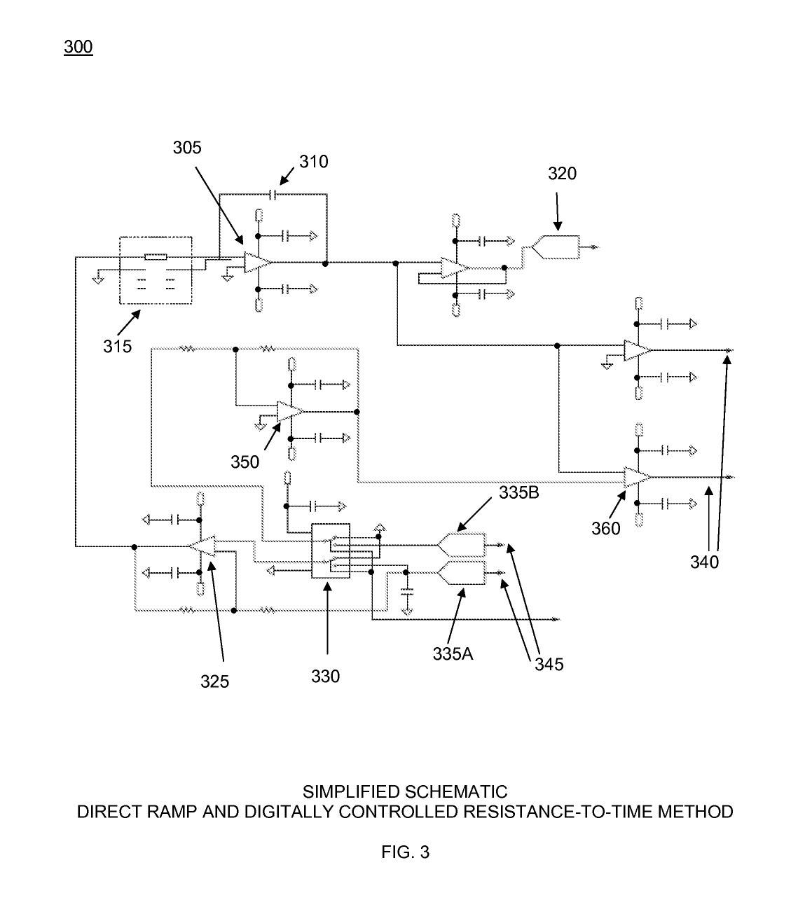

FIG. 3 depicts a component diagram 300 of an embodiment configured in accordance with the present invention. Precision operational amplifier 305 with capacitor 310 and sensor 315 electrodes form a precision integrator. The output signal that is proportional to resistance/capacitance is optionally buffered and optionally connected to a high speed high resolution analog to digital converter (ADC) 320. Digital to analog converters (DACs) 335A and 335B connect 345 to MCU. Operational amplifier 325 with switch 330 and DAC 335A form a precision bipolar source that drives the cell with alternating drive level of amplitude A determined by DAC 335A. Op amp 350 with DAC 335B and switch 330 form a second precision bipolar source that provides a second alternating polarity signal of amplitude B determined by DAC 335B as the reference signal to comparator 360. Digital outputs 340 connect to MCU.

For embodiments using parallel plate electrodes, the cell constant can be estimated as the ratio of the overlap area to the plate separation. For multi-element cells, the total cell constant is the sum of the partial cell constants that are placed in parallel. For embodiments with a coaxial configuration for the electrodes, capacitance can be calculated as:

$${C}_{coax} = \frac{2 π ɛ l}{ln \frac{b}{a}} \qquad 8 )$$

The cell constant is:

$${K}_{coax} = \frac{2 π l}{ln \frac{b}{a}} \qquad 9 )$$

For an embodiment, a=0.16″, b=0.2″, l=1″, and the cell constant is K=0.715 m. Measurements ranges are described by:

$$R = \frac{1}{σ} \times \frac{l}{Area} = \frac{1}{σ} \times \frac{1}{K} \qquad 10 )$$

From this electrode cell constant and a minimum conductivity of about 500 pS/m or about 0.5×10⁻⁹ S/m, maximum resistance (R_{MAX}) can be calculated:

$${R}_{MA X} = \frac{1}{σ} \times \frac{1}{K} = \frac{1}{0.5 \times {10}^{- 9}} \times \frac{1}{0.715} = 1 \times {10}^{10} = 2.8 G Ω \qquad 11 )$$

Embodiment circuitry measures such low conductivity by adjusting A (V_{exc}).

C_{MAX}

The dielectric constant range is determined by the constraint on cell capacitance and the cell constant. For a drive signal, A, and a trigger level, B, the maximum cell capacitance is related to the integrator capacitance,

Cₛ <ξ(B/A)Cᵢ 12)

Where ξ=1 for the time-interval method and ξ=2 for the direct ramp measurement. For simplicity, assume Cₛ<Cᵢ for a 100 pF limit.

Cₛ=εᵣε₀K 13)

Therefore, ε_{MAX} is:

ε_{MAX}<100/8.8542/0.715=15.8 14)

For embodiments, in order to measure to εᵣ=80, either a 500 pF integrating capacitor is needed or the cell constant must be correspondingly reduced, or the B/A ratio must be increased.

Circuitry embodiments are capable of measuring such a range of capacitance by adjusting V_{exc}(A).

### Direct Ramp Measurement

To overcome certain limitations, such as the dielectric constant range at a given B/A ratio, a direct ramp measurements method may be used. The method uses direct sampling of the integrator output V_{OP} and calculating equivalent R_{SENS} and C_{SENS}. R_{SENS} is calculated as:

$${R}_{SENS} = \frac{\frac{A}{C}}{α} \qquad 15 )$$

Where a is the linear slope,

C_{SENS} can be calculated as:

$${C}_{SENS} = \frac{β}{\frac{A}{C}} \qquad 16 )$$

Where β is the Voltage drop.

Direct ramp measurements method embodiments avoid imperfections of the components and provide very accurate measurement, especially when averaging is used. The approach is also able to suppress the influence of parasitic inductance and external resistance-capacitance time constants of a cell and, with additional analysis of the deviations from ideal, to quantify these additional parameters.

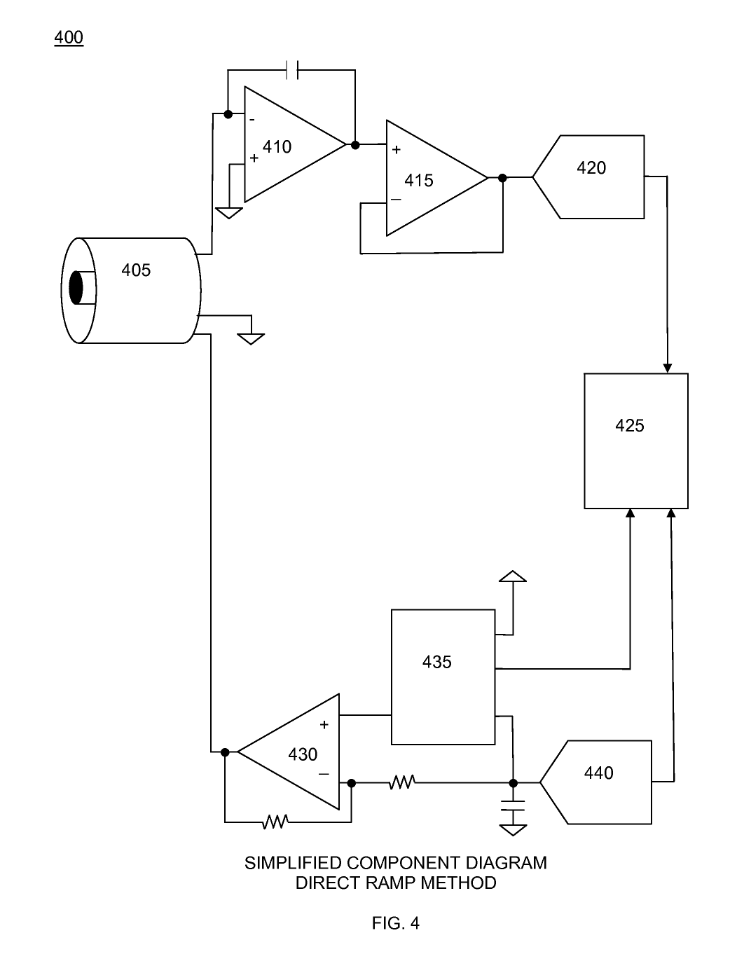

FIG. 4 depicts a simplified component embodiment diagram 400. Components comprise sensor 405; precision amp integrator 410; voltage buffer 415; ADC 420; MCU 425; op amp 430; switch 435; and DAC 440.

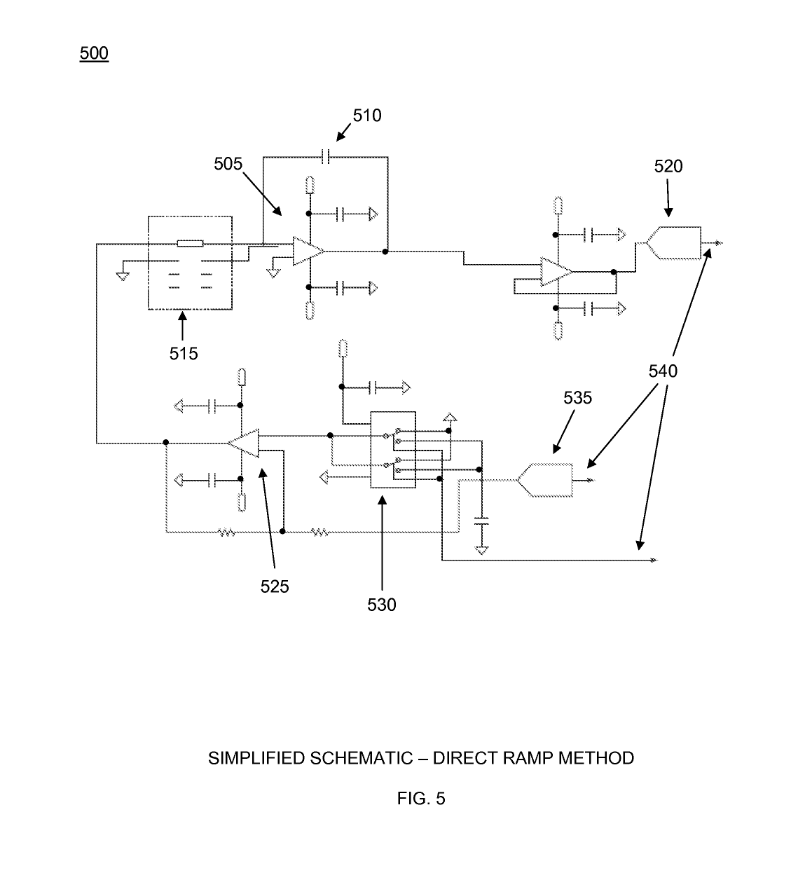

FIG. 5 depicts a component embodiment diagram 500. Low noise operational amplifier 505 with capacitor 510 of, by way of non-limiting example, 100 pF and sensor 515 electrodes form a precision integrator. The output signal that is proportional to resistance/capacitance is buffered and connected to a high speed high resolution analog to digital converter 520. Operational amplifier 525 with switch 530 and DAC 535 form a precision bipolar source that drives the cell. The switching and measurement start/stop is controlled by a digital signal. Lines 540 interface with MCU. In embodiments, amplitude (A or V_{exc}) of the bipolar source is programmed by the DAC, allowing adjustment of the measurement gain dynamically, on the fly. This feature provides reduction of measurement time, range optimization, and scaling gain separately for resistance and capacitance measurements.

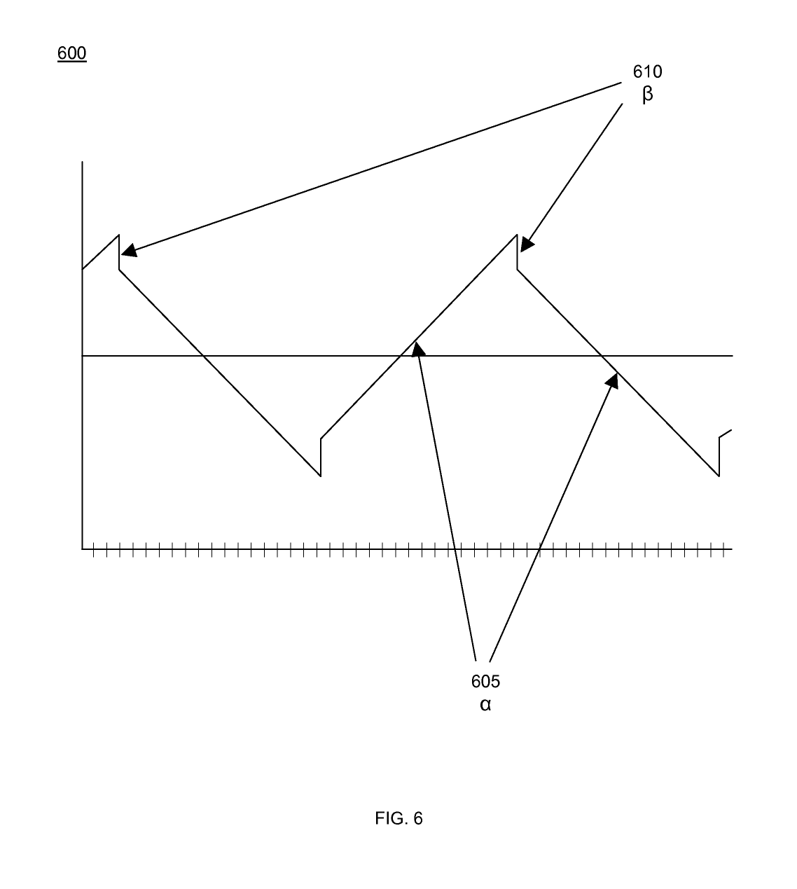

For embodiments, measurement starts with setting the switch after the ADC starts collecting data. When V_{OP} reaches a certain value, the switch is flipped while the ADC continues to collect data. The collected data contains positive and negative ramp (i.e. a in FIG. 6) and the peak drop (i.e. β in FIG. 6). The α and β values can be calculated by combination of interpolation and peak detection algorithms. The measurement accuracy can be further improved when averaging is used.

For embodiments, the ADC sampling frequency is selected to have about at least 1,000 samples for each measurement cycle. For a given range, embodiments have a sampling frequency between about 0.1 and about 1 Ms/s. The resultant data rate can involve commensurate memory resources.

FIG. 6 is a depiction of timing slope and drop results 600 for an embodiment using a direct ramp measurements method. As discussed above, it shows V_{OP} Timing diagram slope (a) 605 and drop (β) 610 for R_{SENS}=2.2GΩ and C_{SENS}=47pF. The graph depicts 400 ms/division. The method uses direct sampling of the integrator output V_{OP} and calculating equivalent R_{SENS} and C_{SENS}. R_{SENS} is calculated as:

$${R}_{SENS} = \frac{\frac{A}{C}}{α} \qquad 17 )$$

Where α 605, is the line slope,

As previously, C_{SENS} can be calculated as:

$${C}_{SENS} = \frac{β}{\frac{A}{C}} \qquad 18 )$$

Where β 610 is the Voltage drop.

FIG. 7 depicts the distortions of the ideal waveform that might be seen in real embodiments. In a non-ideal implementation of the system, there exist external resistance, inductance, and capacitance that distort the switching discontinuity, β, 701, 701a. These RC time constants introduce a source of error into TC1 and TC3 for time interval measurements and also incur an error Δβ in the estimation of the discontinuity. The direction and magnitude of the errors depend on the estimation methods that are used. The ramp method allows the ramps to be extrapolated to properly obtain a compensated discontinuity magnitude and directly determines the slope, independent of timing errors.

Another non-ideal behavior is the finite switching time of the comparator, ΔTC2, which causes an overshoot 703 of the signal past the switching trigger threshold, B, to an effective switching threshold, B′. The increase in the effective switching trigger point depends on the comparator speed, ΔTC2, and the ramp rate, α. The ramp rate is determined by the excitation voltage, A, and the cell conductance, G=1/R. The overshoot and the associated errors in TC2 and TC4 may be reduced by adequate comparator selection and by controlling the excitation voltage, A, to a suitably small value. Overshoot is a problem primarily in time interval methods; the directly digitized method overcomes this at the expense of computational resources.

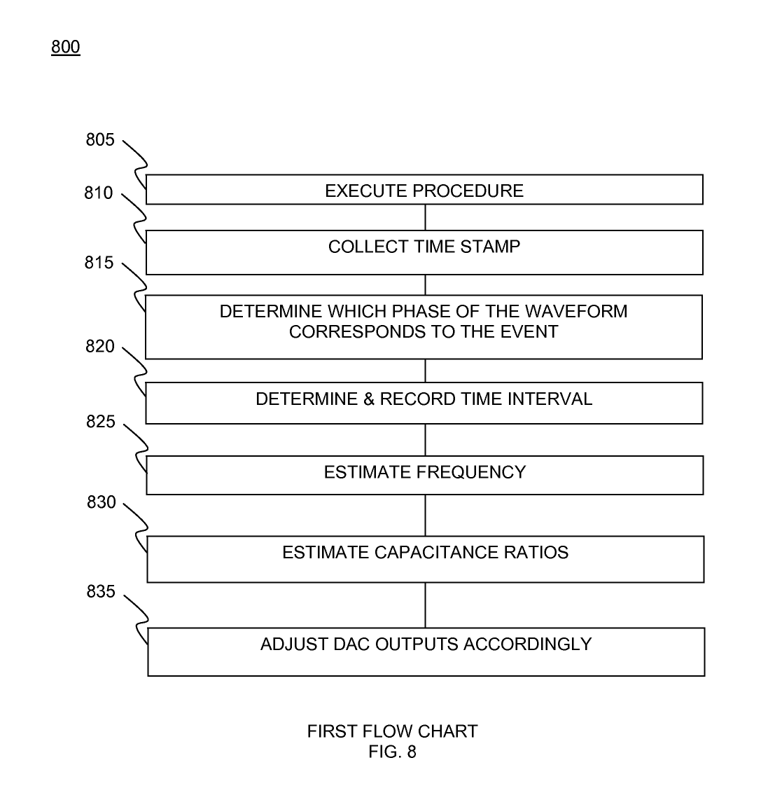

FIG. 8 is a first flow chart of a method 800 comprising the steps of: at each input capture event: executing a procedure such as calling an interrupt service routine 805; that collects the time stamp 810; determines which phase of the waveform corresponds to the event 815; determine and records the time interval 820; estimates the frequency 825; and capacitance ratios 830; and adjusts the DAC outputs accordingly to attain a desired frequency 835.

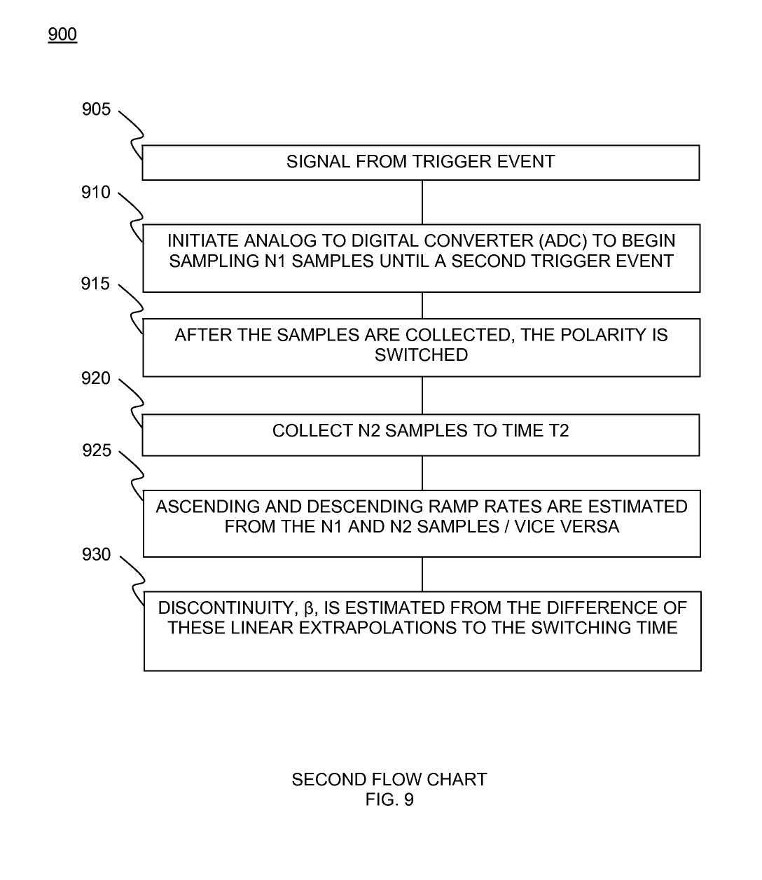

FIG. 9 is a second flow chart of a method 900 comprising the steps of: trigger signal 905 initiating an analog to digital converter (ADC) to begin sampling a number, N1, of samples 910; after the samples are collected, the polarity is switched 915; the waveform continues to be digitized for an additional N2 samples 920; the ascending and descending ramp rates are estimated from the N1 and N2 samples or vice versa 925; the discontinuity, β, is estimated from the difference of these linear extrapolations to the switching time 930. In embodiments, the frequency is only significant in that it controls the period at which measurements are made. As mentioned, drive signal A can be increased to maximize the resolution of the dielectric constant measurement. It may also be adjusted to optimize the duration of the digitization process and the numerical accuracy of the slope calculations. N1 and N2 may be fixed numbers or may be arbitrary numbers attained up to a switching voltage. For embodiments, N1 is based on time, voltage, or a predetermined number. For some embodiments, steps comprise repeating steps of taking N1 samples, switching polarity, and taking N2 samples. Memory requirements, in embodiments, are derived from the number of samples N1 and N2 plus buffering. N1 and N2 can be chosen to optimize sampling. Analyzing samples provides two slopes and discontinuity parameters. Embodiments utilize the clock rate from the time stamp.

The various embodiments of the present invention are applicable to numerous measurement requirements. The embodiments may be applied to the measurement of physical resistors and capacitors, to the equivalent parallel RC circuit of a device, or to the measurement of material properties. In one set of embodiments, the system and method are applied to the measurement of a thin film printed element having a capacitance or conductance (1/resistance) that varies in response to a physical or chemical influence. One such example would be a chemiresistive semiconducting metal oxide film with a catalyst, such as gold doped tungsten trioxide. When such films are exposed to hydrogen sulfide at elevated temperatures, the gold-catalyzed splitting of H2S into surface radicals of hydrogen and sulfur results in a change in the number of carrier electrons of the tungsten trioxide semiconductor. Other chemiresistive films are well known in the literature and their measurement is one objective. Polymer chemiresistive films are also known. Another set of applications are drawn to the measurement of capacitance change in polymer capacitors due to water uptake (humidity sensors), alcohol uptake and the like. In these sensors a change in a known material is related to a physical or chemical property.

In another set of sensors, the electrodes and instrumentation are the sensor and the properties of an intervening material are measured. Such applications include the measurement of leakage conductance in electronic materials, the dielectric properties of plastics, and other solid material applications. In another set of applications, the electrodes are immersed in a fluid and the fluid conductivity and/or dielectric constant are measured. One such application is to monitor contamination of an insulating or lubricating oil by water or glycol.

These applications share an initial step of measuring the resistance and capacitance seen at the electrical terminals of the measurement circuit. Applications drawn to measuring material properties further employ a predetermined cell constant to derive the material bulk conductivity and dielectric constant from the directly measured properties.

The foregoing description of the embodiments of the invention has been presented for the purposes of illustration and description. Each and every page of this submission, and all contents thereon, however characterized, identified, or numbered, is considered a substantive part of this application for all purposes, irrespective of form or placement within the application. This specification is not intended to be exhaustive or to limit the invention to the precise form disclosed. Many modifications and variations are possible in light of this disclosure.

What is claimed is:

1. A system for instrumenting a sensor for measuring electrical properties of a material comprising:
a sensor having an input and an output, interfaced with;
a first drive signal source, said source driving a first polarity switching means driving said input of said sensor with drive signal of said first drive signal source, wherein said drive signal is applied with alternating polarity;
an integrator integrating output current of said sensor, said output current responsive to input voltage of said first drive signal;
said integrator response further coupled to
a first comparator, said comparator comparing said output of said integrator to a constant reference level and generating a first digital output signal;
a second comparator, said comparator comparing said output of said integrator to an alternating polarity reference and providing a second digital output signal, said alternating polarity reference obtained from a second polarity switching means providing said alternating polarity reference voltage, said second polarity switching means switching polarity of a signal obtained from;
a second drive signal source;
wherein said second digital signal controls said first and second polarity switching means,
said digital output signals being coupled to a computing means, said computing means analyzing times between transitions of said digital signals to determine said electrical properties of said material, said electrical properties comprising at least one of conductivity, resistivity, conductance, resistance, dielectric constant, dielectric loss tangent, or capacitance,
wherein said computing means further controls amplitude of at least one of said first and second drive signals.

2. The system of claim 1 wherein amplitude of said first drive voltage signal is adaptively controlled to prevent electrolysis of said material being measured.

3. The system of claim 1, wherein said first drive voltage signal is derived from a digital to analog converter (DAC).

4. The system of claim 1, wherein said second drive voltage signal is generated by a digital to analog converter (DAC).

5. The system of claim 1, wherein said first switching means comprises a comparator and said first drive voltage signal is derived from power supplies of said comparator.

6. The sensor of claim 1 comprising:
a free running relaxation oscillator, wherein output of said integrator is further coupled to a data acquisition means accomplishing digitization of at least a portion of said output of said integrator, wherein said computing means estimates slopes and discontinuities of said output and estimates said material's electrical properties therefrom.

7. The sensor of claim 6, wherein said digitization comprises digitizing a free running waveform and then identifying features of measurement.

8. The system of claim 1 comprising a free running relaxation oscillator with at least one of said first and second drive signals adaptively controlled, whereby time intervals are optimized for measurement quality.

9. The system of claim 1 wherein said free running relaxation oscillator is controlled to control measurement frequency at a desired frequency.

10. The system of claim 9 wherein said free running relaxation oscillator sequentially adaptively controls said at least one drive level to sequentially perform measurements of said material at a plurality of frequencies, so as to determine dependence of the measured electrical parameters on frequency.

11. The sensor of claim 6, wherein sampling frequency is at least about approximately about 1,000 samples for each measurement cycle.

12. The sensor of claim 6, wherein sampling frequency is about approximately between 0.5 and 1 Ms/s.

13. The sensor of claim 1, wherein asymmetry is monitored, leakage current is estimated, and time intervals are compensated for said leakage current.

14. A system for instrumenting a sensor for measuring electrical properties of a material comprising:
a sensor having an input and an output, interfaced with;
a drive signal source; said source driving a polarity switching means driving an input of said sensor with said drive signal input voltage applied with alternating polarity;
an integrator integrating output current of said sensor, said output current responsive to said input voltage;
said integrator response further coupled to
a data acquisition means for the purpose of digitization of at least a portion of said output of said integrator into a computing means;
said computing means estimating slopes and discontinuities of said integrator output, estimating said material's electrical properties therefrom; and
said alternation of said drive signal polarity further controlled by said computing means.

15. The sensor of claim 14, wherein sampling frequency is at least about approximately 1,000 samples for each measurement cycle.

16. The sensor of claim 14, wherein sampling frequency is about approximately between 0.5 and 1 Ms/s.

17. A method for measuring electrical properties of a material in contact with a sensor comprising the steps of:
performing, at each event associated with a change of state of digital signals of an instrumentation means;
collecting a time stamp;
determining which phase of a waveform corresponds to said event;
recording a time interval;
optionally estimating a frequency;
estimating sensor capacitance at a predetermined subset of said events; and
adjusting digital to analog converter DAC outputs at a predetermined subset of said events;
whereby at least one of drive level and trigger level is adaptively controlled to maintain said time intervals or said frequency within a desired range.

18. The method of claim 17, wherein said time intervals are averaged.

19. The method of claim 17, wherein a single frequency is used.

20. The method of claim 17, wherein multiple frequencies are used sequentially.

21. The method of claim 17, comprising:
triggering on a level less than a switching level;
digitizing a rising slope to a second trigger level under software control;
estimating at least one of said rising slope and a falling slope;
switching a drive signal;
digitizing a signal until a third trigger level is reached under software control;
estimating at least one of said rising slope and said falling slope; and
estimating a discontinuity at switching time.

22. A method for measuring electrical properties of a material in contact with a sensor comprising the steps of:
initiating an analog to digital converter (ADC) by a trigger signal;
sampling a first predetermined number of samples;
switching polarity after said first predetermined number of samples are collected;
sampling a second predetermined number of samples;
estimating at least one of an ascending ramp rate or a descending ramp rate from said collected first predetermined number of samples and estimating the other of said ascending ramp rate or said descending ramp rate from said collected second predetermined number of samples;
further estimating a discontinuity (β) from difference of these linear extrapolations to switching time; and
estimating said electrical properties of said material using at least one of said slopes and said discontinuity.
